(19) United States
(12) Patent Application Publication
(10) Pub. No.: US 2006/0069739 A1
(43) Pub. Date: Mar. 30, 2006

(54) Method and apparatus for encoding design description in reconfigurable multi-processor system

(75) Inventors: Krishnamurthy Vaidyanathan, Bangalore (IN); Geoffrey Francis Burns, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V.

(21) Appl. No.: 10/538,205

(22) PCT Filed: Dec. 8, 2003
(86) PCT No.: PCT/IB03/05760

§ 371 Date: Jun. 9, 2005

(30) Foreign Application Priority Data
Dec. 11, 2002 (US) 60432537

(51) Int. Cl. G06F 15/167

(52) U.S. Cl. 709/213

(57) ABSTRACT

A method (400) and apparatus (100) are disclosed for storing the software specifications (320) for each processor (110) in a multi-processor system (100). The disclosed storage technique reduces the total memory space that is required to store the configuration information for each processor (110) and does not require a linear scaling of the memory size when the number of processors increases. Each unique software specification (320) is stored in memory and a pointer (310) is stored for each processor (110) that identifies the corresponding location in memory (140′) of the configuration information for the processor (110). The size of the memory area that stores the pointers (310) for each processor (110) still has a linear relationship with the number of processors (110). The size of the memory area (140′) that stores the unique software specifications (320) is independent of the number of processors (110).

The present invention relates to reconfigurable multi-processor systems, and more particularly, to techniques for efficiently storing the program code that defines the functionality of each processor in the multi-processor system.

For many applications, a single digital signal processor may be incapable of providing the necessary processing bandwidth. Thus, the processor design is often decomposed into several processors operating in parallel to provide a multi-processor system. Typically, each processor is individually programmable with the functionality of each processor being individually defined by a software program that is stored in memory and loaded into the corresponding processor when the system starts up. Thus, the memory size of the multi-processor system generally grows linearly with the number of processors.

For example, if a multi-processor system is designed with 10 processors and each processor requires a specification comprised of 256 bytes, then the total memory required to store the system configuration is 2,560 bytes. If the data rate of the input stream is thereafter increased by an order of magnitude, while retaining the component processors, clock rate and the signal processing function set, then the total number of processors should also be scaled up by an order of magnitude. Therefore, the design would now require 25,600 bytes to specify the software for the required 100 processors.

A need exists for a method and apparatus for storing the configuration information that define the functionality of each processor in the multi-processor system. A further need exists for an efficient method for storing such configuration information that does not require a linear scaling of the memory size when the number of processors increases.

Generally, a method and apparatus are disclosed for storing the software specifications for each processor in a multi-processor system. The disclosed storage technique reduces the total memory space that is required to store the configuration information for each processor and does not require a linear scaling of the memory size when the number of processors increases.

The present invention stores each unique software specification in memory and then stores a pointer for each processor that identifies the corresponding location in memory of the configuration information for the processor. Each pointer refers to, e.g., the address in memory of the start of the software program(s) for a single processor, thereby removing redundant code storage. In this manner, the present invention removes the linear scaling of memory size with the number of processors and makes the memory size independent of the number of processors.

The size of the memory area that stores the pointers for each processor still has a linear relationship with the number of processors. The size of the memory area that stores the unique software specifications, however, is independent of the number of processors, in accordance with the present invention. Processors that are specified by the same software program(s) now share the same program specification in the configuration memory, thereby reducing the total size of the configuration memory.

A more complete understanding of the present invention, as well as further features and advantages of the present invention, will be obtained by reference to the following detailed description and drawings.

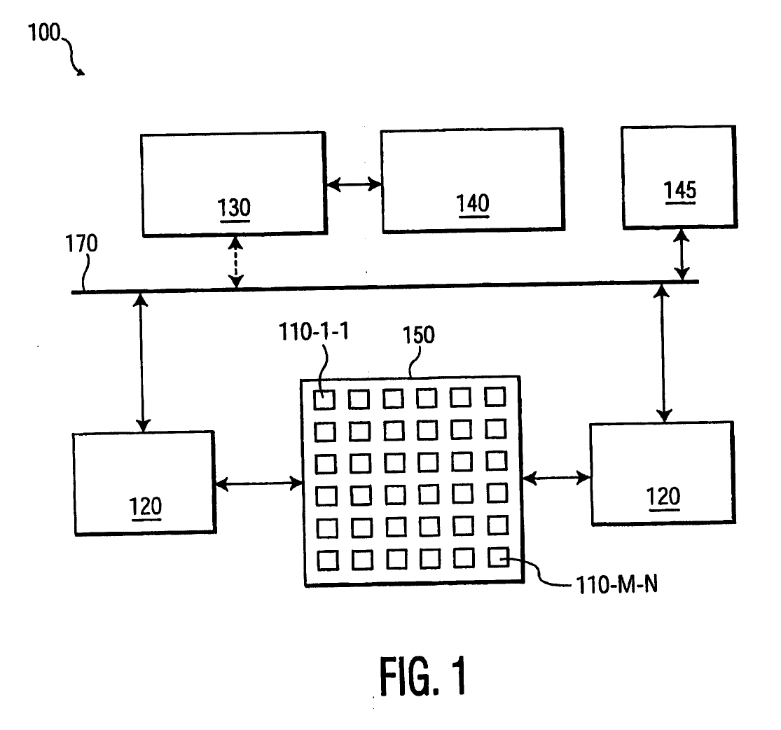

FIG. 1 is a schematic block diagram of an exemplary conventional multi-processor system;

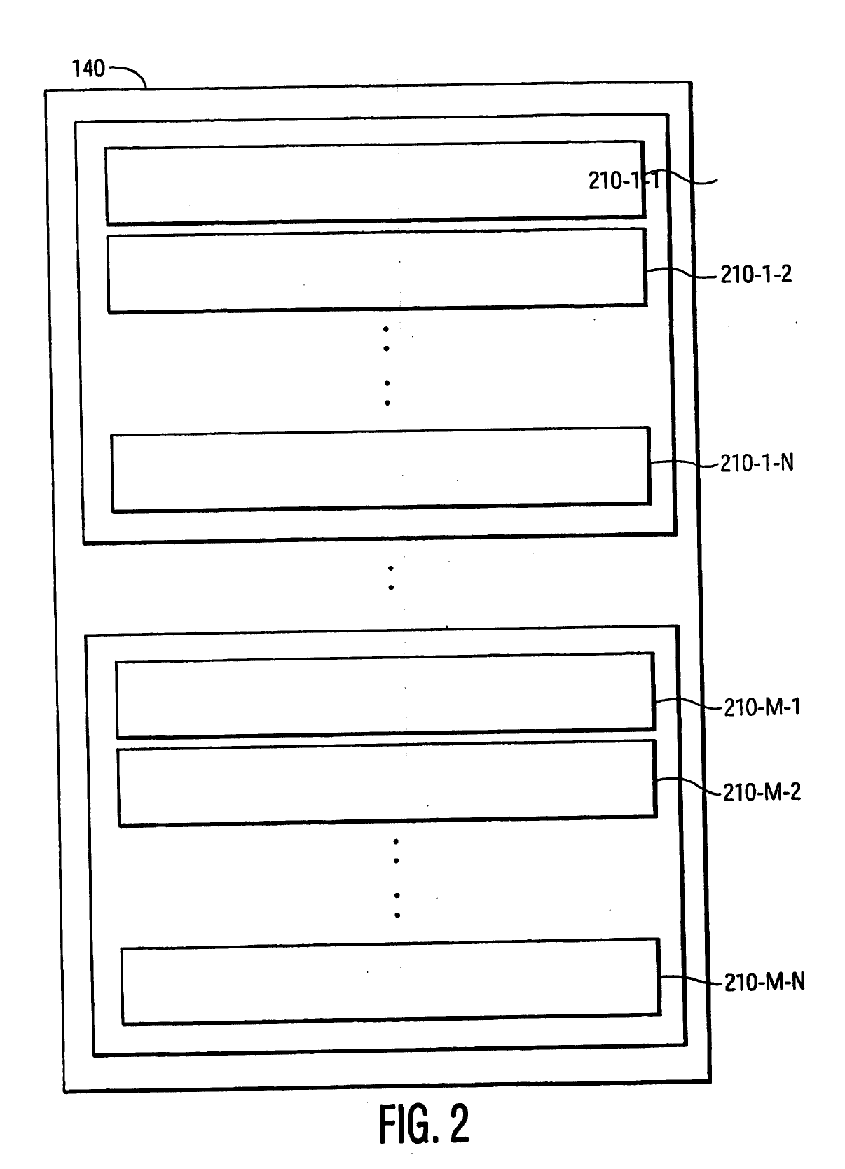

FIG. 2 illustrates a conventional technique for storing the configuration information for each processor in the multi-processor system of FIG. 1;

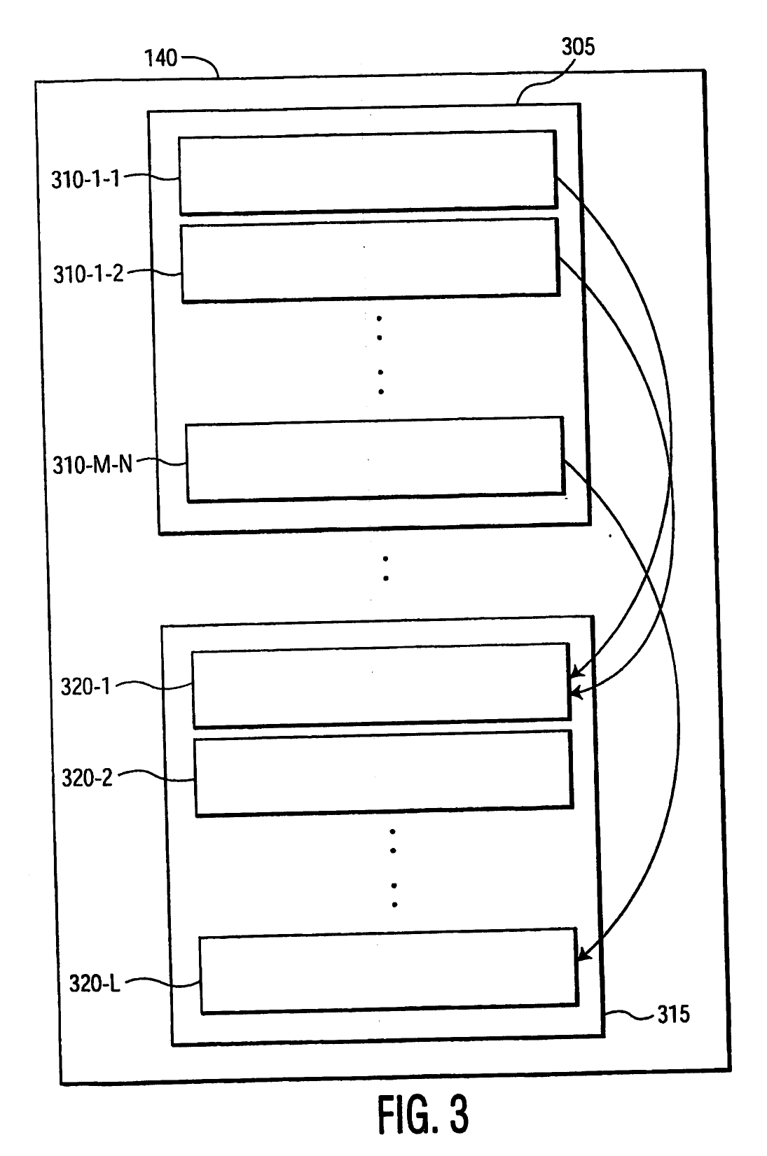

FIG. 3 illustrates a technique for storing the configuration information for each processor of FIG. 1 in accordance with the present invention;

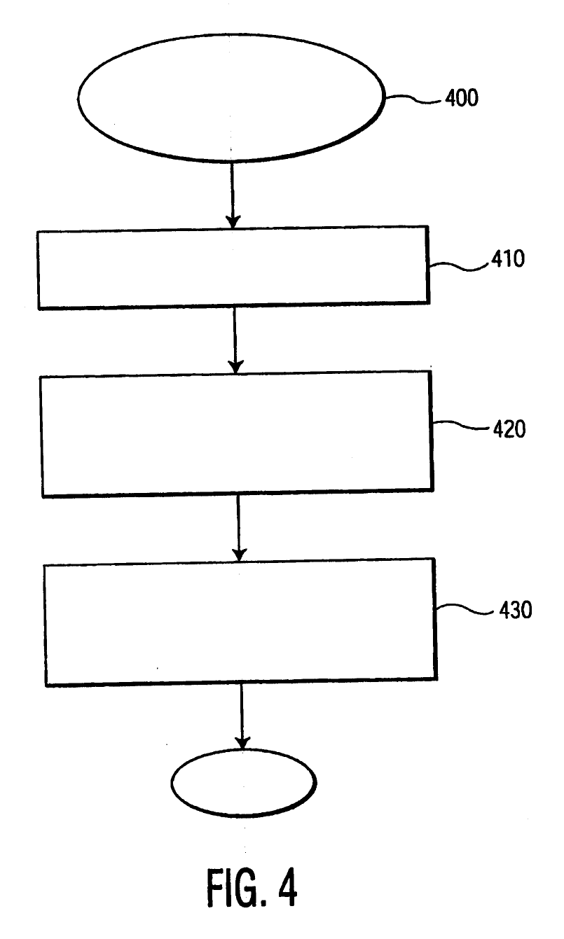

FIG. 4 is a flow chart describing an exemplary processor configuration process where the number of processors and the size of each of the software specifications 320 for each unique program are predefined; and

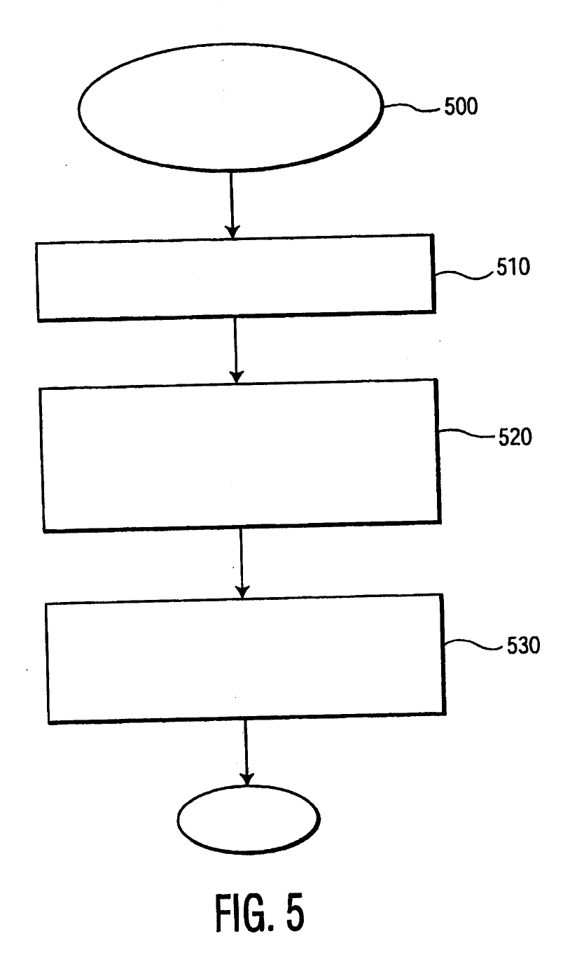

FIG. 5 is a flow chart describing an alternate processor configuration process where the number of processors is known, but and the size of each of the software specifications 320 for each unique program can vary.

The present invention provides an efficient method for storing configuration information for each processor in a multi-processor system that reduces the total memory space and does not require a linear scaling of the memory size when the number of processors increases is described below. The present invention recognizes that many applications, such as digital communication applications, employ algorithms having a property often referred to as “single program multiple data (SPMD),” whereby the same program is loaded into a number of processors in the multi-processor system to process corresponding data in parallel.

According to one aspect of the invention, a list of pointers to the corresponding configuration information for each processor is maintained in memory, rather than storing the individual configuration information for every processor. Each pointer refers to, e.g., the address in memory of the start of the software program(s) for a single processor, thereby removing redundant code storage. In this manner, the present invention removes the linear scaling of memory size with the number of processors and makes the memory size independent of the number of processors for the strictly SPMD case.

FIG. 1 is a schematic block diagram of an exemplary conventional multi-processor system 100. As shown in FIG. 1, the multi-processor system 100 includes an array 150 of M rows and N columns of processors 110-1-1 through 110-M-N, hereinafter collectively referred to as processors 110. A configuration memory 140 stores the software description for each of the individual signal processors 110. The software description is downloaded to the individual signal processors by the configuration processor 130 and, if necessary, one or more interface processors 120 that control the addressing of the array 150 of processors, in a known manner.

FIG. 2 illustrates a typical conventional technique for storing the configuration information for each processor 110 in the multi-processor system 100. As shown in FIG. 2, a conventional configuration memory 140 stores individual images of the software description 210-1-1 through 210-M-N for each corresponding processor 110-1-1 through 110-M-N. As previously indicated, the memory storage technique shown in FIG. 2 leads to a linear scaling of the size of the configuration memory 140 when the number of processors 110 in the array 150 increases.

FIG. 3 illustrates a technique for storing the configuration information for each processor 110 in accordance with the present invention. As shown in FIG. 3, the configuration memory 140 contains a first region 305 containing a pointer 310-1-1 through 310-M-N (hereinafter, collectively referred to as pointers 310) for each corresponding processor 110-1-1 through 110-M-N. In addition, the configuration memory 140 contains a second region 315 containing a software specification 320-1 through 320-L for each unique program 1 through L. Thus, the pointer 310 for a given processor 110 points to the appropriate area of region 320 containing the software specification 320 to be implemented by the processor 110.

The first region 305 has a size that has a linear relationship with the number of processors. Since the maximum number of processors can be pre-defined, however, a fixed memory size may be allocated for the first region 305. The second region 315, where the actual software programs are stored, has a size that is independent of the number of processors, in accordance with the present invention. Processors 110 that are specified by the same software program now share the same program specification 320 in the configuration memory 140, thereby reducing the total size of the configuration memory 140. In this manner, the present invention removes the redundant specification of software programs from the configuration memory 140.

FIG. 4 is a flow chart describing an exemplary processor configuration process 400 where the number of processors and the size of each of the software specifications 320 for each unique program are predefined. The processor configuration process 400 is typically implemented by the configuration processor 130. As shown in FIG. 4, the processor configuration process 400 initially obtains the total number of processors and program length during step 410.

Thereafter, for each processor, the processor configuration process 400 retrieves the appropriate pointer 310 to the corresponding program 320 in the configuration memory 140 during step 420. Finally, for each processor, the retrieved pointer 310 for each processor 110 is used to retrieve the program 320 identified by the pointer 310 during step 430 and load the identified program 320 into the appropriate processor 110. Program control then terminates. The file format for the processor configuration in memory 140′ can be expressed as follows:
1. Dimension (M,N) of Processor array;
2. Length of Program;
3. For (row=1, col=1) to (row=M, col=N) pointer to program for processor(row,col); and
4. For (I=1 to L, where L is max number of unique programs) Program(i).

The pseudocode for the processor configuration process 400 can then be expressed as follows:

```
For (row=1, col=1) to (row=M,col=N){
  For(instr=1) to (instr=L){
    Instruction instr in processor (row,col) = *(pointer(row,col)+instr)
  }
}
```

FIG. 5 is a flow chart describing an exemplary processor configuration process 500 where the number of processors is known, but and the size of each of the software specifications 320 for each unique program can vary. Thus, when the individual unique programs can have varying lengths, the program length is encoded along with the pointer. The processor configuration process 500 is typically implemented by the configuration processor 130. As shown in FIG. 5, the processor configuration process 500 initially obtains the total number of processors during step 510.

Thereafter, for each processor, the processor configuration process 500 retrieves the appropriate pointer 310 to the corresponding program 320 in the configuration memory 140, as well as the length of the program, during step 520. Finally, for each processor, the retrieved pointer 310 for each processor 110 is used to retrieve the program 320 identified by the pointer 310 during step 530 and load the identified program 320 into the appropriate processor 110. Program control then terminates. The file format for the processor configuration in memory 140′ can be expressed as follows:
1. Total number of processors
2. For (row=1, col=1) to (row=M, col=N) pointer to program for processor(row,col), Length of program
3. For (I=1 to L, where L is max number of unique programs) Program(i)

The pseudocode for the processor configuration process 500 can then be expressed as follows:

```
For (row=1, col=1) to (row=M,col=N){
  For(instr=1) to (instr=L(row,col)){
    Instruction instr in processor (row,col) = *(pointer(row,col)+instr)
  }
}
```

The present invention can be applied to the MSCD Reconfigurable Processor Array described in G. Burns et al., “Array Processing for Channel Equalization,” IEEE Int'l Conf. on Acoustics, Speech and Signal Processing, ICASSP 2002 (May 13, 2002), incorporated by reference herein. If a finite impulse response filter tap calculation takes five cycles on each processor, and there are 128 filter taps, and one tap per processor, at least 640 words (5*128) are required in the configuration memory 140. The present invention recognizes that all processors are implementing the same signal processing function and that the number of unique programs is one. The configuration memory then requires 128 words to store the pointers and five words to store the single unique program yielding a total of 133 words (128+5). Thus, the present invention provides a savings of nearly 80%.

In addition, a further reduction in memory size in the region 305 of the configuration memory 140 that contains the pointers 310 can be achieved by implementing run-length encoding techniques if several processors are unused. Additional reductions in memory size in the region 315 of the configuration memory 140 that contains the actual software specifications 320 can be achieved by using REPEAT key words when the same opcode is repeated contiguously. For example, the configuration memory 140 can be encoded as follows:
REPEAT 5{
NOP
}

The individual processor or the configuration processor 130 can recognize the REPEAT keyword to trigger an expansion of the above encoding as follows:
NOP
NOP
NOP
NOP
NOP

In this manner, if such an opcode expansion is supported in the individual processor hardware, itself, then the array cell local opcode storage can become substantially more efficient. All known types of binary compression algorithms may be used in conjunction with the present invention to further reduce the total memory size.

It is to be understood that the embodiments and variations shown and described herein are merely illustrative of the principles of this invention and that various modifications may be implemented by those skilled in the art without departing from the scope and spirit of the invention.

1. A method for storing at least one software specification for a plurality of processors in a multi-processor system, comprising the steps of:
storing each unique software specification in a memory; and
storing a pointer for each of said plurality of processors, each of said pointers identifying a location of said memory storing a software specification associated with said processor.

2. The method of claim 1, further comprising the step of retrieving a pointer to a corresponding program software specification for a given processor.

3. The method of claim 2, further comprising the step of retrieving said software specification identified by said pointer.

4. The method of claim 3, further comprising the step of loading said retrieved software specification into said given processor.

5. The method of claim 1, wherein each unique software specification has a uniform length.

6. The method of claim 1, wherein one or more of said pointers are encoded using run length encoding techniques.

7. The method of claim 1, wherein at least one of said unique software specifications is stored in a compressed format using a keyword that indicates that an associated operational code should be repeated.

8. A multi-processor system, comprising:
a plurality of processors; and
a memory coupled to said plurality of processors, said memory including:
a first region for storing one or more unique software specifications and
a second region for storing a pointer for each of said plurality of processors, each of said pointers identifying a location of said memory storing a software specification associated with said processor.

9. The multi-processor system of claim 8, wherein at least one of said plurality of processors is configured to retrieve a pointer to a corresponding program software specification for a given processor.

10. The multi-processor system of claim 9, wherein at least one of said plurality of processors is configured to retrieve said software specification identified by said pointer.

11. The multi-processor system of claim 10, wherein at least one of said plurality of processors is configured to load said retrieved software specification into said given processor.

12. The multi-processor system of claim 8, wherein each unique software specification has a uniform length.

13. The multi-processor system of claim 8, wherein one or more of said pointers are encoded using run length encoding techniques.

14. The multi-processor system of claim 8, wherein at least one of said processors recognizes a keyword that indicates that an associated operational code in one of said software specifications should be repeated.

15. A method for loading a software specification into a processor in a multi-processor system, comprising the steps of:
retrieving a pointer associated with said processor that identifies a corresponding software specification in a memory;
retrieving said corresponding software specification identified by said pointer; and
loading said retrieved software specification into said processor.

16. The method of claim 15, wherein said software specification has a predefined length.

17. The method of claim 15, wherein said pointer is encoded using run length encoding techniques.

18. The method of claim 15, wherein said software specifications is stored in a compressed format using a keyword that indicates that an associated operational code should be repeated.

19. The method of claim 18, further comprising the step of expanding said operational code an indicated number of times.

20. The method of claim 18, wherein said software specification is stored only once in said memory.
